(19) United States
(12) Patent Application Publication
(10) Pub. No.: US 2021/0102082 A1
(43) Pub. Date: Apr. 8, 2021

(54) SPRAYABLE WATER-REPELLENT INK FOR DIGITAL PRINTING PROCESS OF FABRIC AND WATER-REPELLENT FABRIC

(71) Applicant: TAIWAN TEXTILE RESEARCH INSTITUTE, New Taipei City (TW)

(72) Inventors: Jung-Yu Tsai, New Taipei City (TW); Chia-Yi Lin, New Taipei City (TW)

(21) Appl. No.: 17/033,990

(22) Filed: Sep. 28, 2020

(30) Foreign Application Priority Data
Oct. 3, 2019 (TW) 108135946

(51) Int. Cl. C09D 11/30; C09D 11/106; C09D 11/102; D06P 5/30; D06M 15/564; D06M 15/256; B41M 5/00

(52) U.S. Cl. CPC C09D 11/30; C09D 11/106; C09D 11/102; D06P 5/30; D06P 3/526; D06M 15/256; B41M 5/0023; B41M 5/0047; B41M 5/0064; D06M 15/564

(57) ABSTRACT

A sprayable water-repellent ink for a digital printing process of a fabric includes 25 parts by weight to 35 parts by weight of a water repellent, 15 parts by weight to 25 parts by weight of a humectant, 0.5 parts by weight to 2 parts by weight of a surfactant, and 35 parts by weight to 60 parts by weight of a solvent. The water repellent has a pH value between 1.5 and 6, and a specific gravity between 0.8 and 1.5 at 20° C. to 25° C.

### RELATED APPLICATION

This application claims priority to Taiwan Application Serial Number 108135946, filed Oct. 3, 2019, which is herein incorporated by reference.

### BACKGROUND

### Field of Invention

The present disclosure relates to a sprayable water-repellent ink, and particularly relates to a sprayable water-repellent ink for a digital printing process on a fabric, and a water-repellent fabric sprayed with the ink.

### Description of Related Art

In recent years, the awareness of family leisure and health has gradually increased, and hence the consumer demand for functional fabrics has also increased. One of the functional fabrics popular among consumers is the water-repellent fabric, which not only can withstand drizzle, but also has air permeability to keep bodies dry. Therefore, how to perform the water-repellent process on fabrics is one of the most important developments of post-treatment in recent years. However, some problems still exist in traditional water-repellent coating process (such as screening process, rolling process, padding process, and foam coating process) because of the limitations of the process. The problems caused by the limitations may be the low usage rate of chemical agents, the inability to stably process, the excessive thickness of water-repellent coatings, the long sampling time, the difficulty of uniform distribution of water-repellent coatings, the unstable fabric quality, etc.

### SUMMARY

A sprayable water-repellent ink of the present disclosure for a digital printing process of a fabric includes 25 parts by weight to 35 parts by weight of a water repellent, 15 parts by weight to 25 parts by weight of a humectant, 0.5 parts by weight to 2 parts by weight of a surfactant, and 35 parts by weight to 60 parts by weight of a solvent, in which the water repellent has a pH value between 1.5 and 6 and a specific gravity between 0.8 and 1.5 at 20° C. to 25° C.

In some embodiments, the water repellent includes a fluorine-based water repellent, a polyurethane water repellent, a silicon-based water repellent, a wax water repellent, or combinations thereof.

In some embodiments, the water repellent is an aqueous fluorocarbon polymer water repellent, and a content of the aqueous fluorocarbon polymer water repellent is 29 parts by weight to 30 parts by weight.

In some embodiments, the water repellent is an alkyl polyurethane water repellent, and a content of the alkyl polyurethane water repellent is 25 parts by weight to 30 parts by weight.

In some embodiments, a surface tension of the sprayable water-repellent ink is between 25 mN/m and 35 mN/m.

In some embodiments, a viscosity of the sprayable water-repellent ink is between 1 cP and 5 cP.

In some embodiments, each of the particle diameters (D90) of the water repellent, the humectant, and the sprayable water-repellent ink is between 0.001 μm and 1 μm.

In some embodiments, the humectant includes glycerol and triethylene glycol, and a weight ratio of the glycerol to the triethylene glycol is 1.8 to 2.2.

In some embodiments, the sprayable water-repellent ink further includes a thickening agent, a pH modifier, a bacteriostatic agent, or combinations thereof.

A water-repellent fabric of the present disclosure includes a polyester base cloth and a water-repellent layer. The polyester base cloth has a first surface and a second surface facing away from the first surface. The water-repellent layer is disposed on the first surface. The water-repellent layer is formed by spraying the sprayable water-repellent ink of any one of foregoing embodiments on the first surface through the digital printing process, in which a water repellency of the first surface is greater than or equal to 85 under AATCC 22.

These and other features, characteristics, and advantages of the present disclosure can be better understood with reference to the following description and the scope of the claims of the appended patent applications.

It should be understood that the foregoing general description and the following specific description are merely exemplary and explanatory, and are intended to provide a further description of the claimed invention.

### DETAILED DESCRIPTION

In the disclosure, a range represented by “one value to another value” is a schematic representation to avoid listing all the values in the range one by one in the specification. Therefore, the description of a specific numerical range covers any numerical value within the numerical range and the smaller numerical range defined by any numerical value within the numerical range. As in the specification, the arbitrary value and the smaller value range are clearly written.

As used herein, “about”, “approximately”, “essentially”, or “substantially” includes the stated value and the average value within the acceptable deviation range of the specific value determined by those of ordinary skill in the art. The measurement in question and the specific number of errors associated with the measurement (i.e., the limitations of the measurement system) are taken into account. For example, “about” can mean within one or more standard deviations of the stated value, or for example, within ±30%, ±20%, ±15%, ±10%, ±5%. Furthermore, the terms “about”, “approximately”, “essentially”, or “substantially” as used herein can be selected to be a more acceptable range of deviation or standard deviation based on measurement properties, coating properties, or other properties, and it is possible to apply all properties without a standard deviation.

In order to solve the problems mentioned in the prior art, the present disclosure provides a sprayable water-repellent ink and a water-repellent fabric. The sprayable water-repellent ink can be sprayed on a base cloth through a digital printing process, thereby forming a water-repellent fabric. The digital printing process is a discontinuous phase coating process, in which the nozzle of the inkjet device would not contact the processed fabric. The digital printing process has the advantages of the precise positioning, the high usage rate of chemical agents, the reduction of waste discharge, the low process energy consumption, the effective cost reduction, and the rapid sampling in small batches, and so on.

In addition, the applicability of the processed fabric can be developed by the digital printing process through different functional coating designs, the partial coating, and the multi-layer coating on the surface or the interior of the fabrics. The digital printing process can reduce the decline in coating performance caused by traditional coatings interference. In textile industry, finishing plants, coating plants, and surface treating plants can use the sprayable water-repellent ink of the present disclosure to perform the inkjet coating, the inkjet finishing, the precision coating, the surface modification, and the surface and the interior differentiation treatments.

The sprayable water-repellent ink of the present disclosure includes 25 parts by weight to 35 parts by weight of a water repellent, 15 parts by weight to 25 parts by weight of a humectant, 0.5 parts by weight to 2 parts by weight of a surfactant, and 35 parts by weight to 60 parts by weight of a solvent, in which the water repellent has a pH value between 1.5 and 6 and a specific gravity is between 0.8 and 1.5 at 20° C. to 25° C. The pH value is, for example, 2, 2.5, 3, 3.5, 4, 4.5, 5, or 5.5. The specific gravity is, for example, 0.9, 1.0, 1.1, 1.2, 1.3, or 1.4.

In some embodiments, the water repellent may include a fluorine resin water repellent, a non-fluorine resin water repellent, or combinations thereof. For example, the water repellent includes a fluorine-based water repellent, a polyurethane water repellent, a silicon-based water repellent, a wax water repellent, or a combination thereof. In some embodiments, the water repellent is, for example, an aqueous fluorocarbon polymer water repellent, and the content is 29 parts by weight to 30 parts by weight. In other embodiments, the water repellent is, for example, an alkyl polyurethane water repellent, and the content is 25 parts by weight to 30 parts by weight.

In some embodiments, a surface tension of the sprayable water-repellent ink is between 25 mN/m and 35 mN/m. The surface tension is, for example, 26, 27, 28, 29, 30, 31, 32, 33, or 34 mN/m. In some embodiments, a viscosity of the sprayable water-repellent ink is between 1 cP and 5 cP (measured by Brookfield DV2T viscometer). The viscosity is, for example, 2, 3, or 4 cP. When the surface tension and the viscosity of the sprayable water-repellent ink are within the aforementioned ranges, the sprayable water-repellent ink has a good inkjet property, so that the sprayable water-repellent ink can be smoothly ejected by the inkjet device and unlikely to block the nozzle.

In some embodiments, each of the particle diameters (D90) of the water repellent, the humectant, and the surfactant of the sprayable water-repellent ink may be between 0.001 μm and 1 μm. The particle diameter is, for example, 0.2, 0.3, 0.4, 0.5, 0.6, 0.7, 0.8, or 0.9 μm. When the particle diameters of the aforementioned components are in the aforementioned range, the sprayable water-repellent ink has good inkjet property, so that the sprayable water-repellent ink can be smoothly ejected by the inkjet equipment and unlikely to block the nozzle.

In some embodiments, the humectant includes glycerol and triethylene glycol, and a weight ratio of the glycerol to the triethylene glycol is 1.8 to 2.2. The ratio is, for example, 1.9, 2.0, or 2.1. When the weight ratio of the glycerol to the triethylene glycol is in the aforementioned range, the sprayable water-repellent ink has better stability and is unlikely to be aging or become maturation. For example, the sprayable water-repellent ink of the present disclosure can be stored at room temperature for up to 4 months.

In some embodiments, the surfactant includes 2,4,7,9-tetramethyl-5-decyne-4,7-diol ethoxylate, polyether modified organosiloxane, or combinations thereof. The surface tension of the sprayable water-repellent ink can be adjusted by the surfactant.

In some embodiments, the sprayable water-repellent ink further includes a thickening agent, a pH modifier, a bacteriostatic agent, or combinations thereof.

The water-repellent fabric of the present disclosure includes a polyester base cloth and a water-repellent layer. The polyester base cloth has a first surface and a second surface facing away from the first surface. The water-repellent layer is disposed on the first surface. The water-repellent layer is formed by spraying the sprayable water-repellent ink of any of the foregoing embodiments on the first surface through the digital printing process. In some embodiments, a water repellency of the first surface is greater than or equal to 85 measured under AATCC 22. For example, the sprayable water-repellent ink can be sprayed on the polyester base cloth by a drop on demand inkjet machine, and the drop on demand inkjet machines may include a piezoelectric one, a thermal bubble one, a valve one, or an electrostatic one.

In some embodiments, the spraying amount of the sprayable water-repellent ink is between 0.5 gsm and 3.5 gsm, but is not limited thereto. The spraying amount is, for example, 1.0, 1.5, 2.0, 2.5, or 3.0 gsm. The water repellency of the water repellent fabric can be adjusted by the spraying amount.

In some embodiments, the polyester base cloth is completely covered by the water-repellent layer, so that the first surface of the polyester fabric has overall hydrophobicity. In some embodiments, the standard sprayable ink with 10 pixels is sprayed on the first surface of the polyester base cloth, so that the water-repellent layer is distributed in a dotted manner on portions of the first surface of the polyester base cloth, and the other portions of the first surface, which is not covered by the water-repellent layer, can be performed under a hydrophilic process to have hydrophilicity. Therefore, the hydrophobic property of the water-repellent fabric can be easily adjusted through the digital printing process, so that the water-repellent fabric has a wide applicability. In some embodiments, the second surface of the polyester base cloth is not sprayed with any sprayable water-repellent ink, so that the two sides of the water-repellent fabric may have different water repellency. Compared with the traditional water-repellent coating process, the fabric above can be easily formed through the digital printing process, so that the traditional problem in the unstable quality of different functions on the surface and the interior fabrics can be solved.

In some embodiments, the water-repellent fabric can be made into garments such as clothes, coats, or pants. For example, the water-repellent fabric can be made into waterproof and air permeability products with good moisture transmission. The products are, for example, windbreakers, jackets, and so on.

The features of the present invention will be described more specifically below with reference to Experiment 1 to Experiment 3. Although the following embodiments are described, the used materials, the amounts and the ratios, the processing details, the processing procedures, etc. can be appropriately changed without exceeding the scope of the present invention. Therefore, the embodiments described below should not restrict the interpretation of the present invention.

In the following experiments, a water repellent 1, a water repellent 2, and a water repellent 3 were selected to compound the sprayable water-repellent inks.

Water repellent 1: an alkyl polyurethane water repellent, of which the pH value was between 3 and 6, and the specific gravity was 1.0 at 20° C.

Water repellent 2: an aqueous fluorocarbon polymer water repellent, of which the pH value was between 2 and 5, and the specific gravity was 1.1 at 25° C.

Water repellent 3: an aqueous fluorocarbon polymer water repellent, of which the pH value was 2.5, and the specific gravity was between 1.07 and 1.17 at 20° C.

### Experiment 1: Evaluation of Sprayable Water-Repellent Ink

The sprayable water-repellent inks of Experiments 1, 2, and 3 were compounded according to the contents listed in Table 1 below, in which the surfactant 465 and the surfactant 348 were purchased from Air Products and Chemicals, Inc. The sprayable water-repellent inks were sprayed through Epson L310 printer, and each of the surface tension, the pH value, the viscosity, and the particle diameter was all fallen within the ranges listed in Table 2 below.

TABLE 1

| | Experiment 1 | Experiment 2 | Experiment 3 |
|---|---|---|---|
| Water | Water repellent | Water repellent | Water repellent |
| repellent | 1 (26.7 parts | 2 (29.3 parts | 3 (29.3 parts |
| | by weight) | by weight) | by weight) |
| Humectant | Glycerol | Glycerol | Glycerol |
| | (12.4 parts | (13.6 parts | (13.6 parts |
| | by weight) | by weight) | by weight) |
| | Triethylene | Triethylene | Triethylene |
| | glycol | glycol | glycol |
| | (6.2 parts | (6.8 parts | (6.8 parts |
| | by weight) | by weight) | by weight) |
| Surfactant | Surfactant 465 | Surfactant 465 | Surfactant 465 |
| | (0.88 parts | (0.97 parts | (0.97 parts |
| | by weight) | by weight) | by weight) |
| | Surfactant 348 | Surfactant 348 | Surfactant 348 |
| | (0.44 to 0.88 | (0.48 parts | (0 to 0.48 |
| | parts by weight) | by weight) | parts by weight) |
| Solvent | Water | Water | Water |
| | (52.94 to 53.38 | (48.85 parts | (48.85 to 49.33 |
| | parts by weight) | by weight) | parts by weight) |

TABLE 2

| | |
|---|---|
| Surface tension | 25 mN/m to 32 mN/m |
| pH value | 4 |
| Viscosity | 2 cP to 3 cP |
| Particle diameter (D90) | <1 μm |

It can be seen from Table 2 that each of the surface tension, the pH value, the viscosity, and each of the particle diameters (D90) of Examples 1, 2, and 3 was all fallen within the suitable ranges for spraying.

### Experiment 2: Aging Experiment

The sprayable water-repellent inks of Experiments 1, 2, and 3 were performed under an aging experiment at 50° C. for 7 days, and the surface tension, the viscosity, and the particle diameter (D90) of each the sprayable water-repellent ink were measured before and after the aging experiment. The results were listed in Table 3.

TABLE 3

| | Experiment 1 | Experiment 2 | Experiment 3 |
|---|---|---|---|
| Surface tension | 25.6 | 29.3 | 30.0 |
| (mN/m) before | | | |
| Surface tension | 28.6 | 29.5 | 29.2 |
| (mN/m) after | | | |
| Viscosity (cP) before | 2.65 | 2.77 | 2.53 |
| Viscosity (cP) after | 2.78 | 2.71 | 2.53 |
| Particle diameter | 0.0039 | 0.1057 | 0.1201 |
| (D90) (nm) before | | | |
| Particle diameter | 0.0042 | 0.1072 | 0.1197 |
| (D90) (nm) after | | | |

It can be seen from Table 3 that there was almost no different for each of the surface tension, the viscosity, and the particle diameter (D90) of the sprayable water-repellent inks of Experiments 1, 2, and 3 after the aging experiment, and those inks were still suitable for spraying. It is considered that the inks of this experiment had good stability and were unlikely to be aging or become maturation.

### Experiment 3: Evaluation of Water-Repellent Fabric

The sprayable water-repellent inks of Experiments 1 and 3 were sprayed on the surface of the polyester base cloth (basis weight: 43.8 gsm, fiber specification: 20d/24f, warp yarns density: 226 per inch, weft yarns density: 180 per inch, the polyester base cloth is a high-density fabric) through Epson L310 printer to manufacture the water-repellent fabrics 1 to 4, and their hydrophobicity was measured. The spraying methods and the evaluation methods for the water-repellent fabrics 1 to 4 were listed in Table 4 below, in which the water repellency was measured under AATCC 22.

TABLE 4

| | Water-repellent | Water-repellent | Water-repellent | Water-repellent |
|---|---|---|---|---|
| | fabric 1 | fabric 2 | fabric 3 | fabric 4 |
| Sprayable | Experiment 3 | Experiment 3 | Experiment 3 | Experiment 1 |
| water-repellent | | | | |
| ink | | | | |
| Spraying | Full-surface | Standard | Full-surface | Full-surface |
| method | spraying for 1 | spraying with | spraying for 5 | spraying for 5 |
| | time | 10 pixels for 1 | times | times |
| | | time | | |
| Spraying | 0.69 | 0.58 | 2.4 | 3.3 |
| amount | | | | |
| (gsm) | | | | |
| Treatment | Cured at 150° C. | Cured at | Cured at 170° C. | Cured at 170° C. |
| after spraying | for 5 minutes, | 150° C. for 5 | for 1 minute, | for 1 minute, |
| | washed and dried | minutes, | washed and | washed and dried |
| | | washed and | dried | |
| | | dried | | |
| Water | N/A | N/A | 90 | 90 |
| repellency | | | | |
| Hydrophobicity | The coated | The coated | The coated | The coated |
| | surface has | surface has | surface has | surface has |
| | overall | dotted | overall | overall |
| | hydrophobicity, | hydrophobicity, | hydrophobicity | hydrophobicity |
| | and the uncoated | and the | | |
| | surface has | uncoated | | |
| | comparative | surface has | | |
| | hydrophilicity | comparative | | |
| | | hydrophilicity | | |

It can be seen from Table 4 that the hydrophobicity of the water-repellent fabrics can be adjusted by the spraying methods and the spraying times. In addition, the water-repellent fabrics with the sprayable water-repellent inks of these experiments had good water repellency. It is worth noting that the water-repellent layer on the coated surface of the water-repellent fabric 2 was distributed in a dotted manner, so that the uncoated portions of the coated surface and the uncoated surface had comparative hydrophilicity. Consequently, the water-repellent fabric 2 can be manufactured into perspiration clothing. When the coated surface is close to the skin, sweat can be conducted to the uncoated surface to be discharged through the wicking effect resulted from the portion of the surface not covered by the water-repellent layer, thereby keeping the skin dry and refreshing.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure covers modifications and variations of this disclosure provided they fall within the scope of the following claims.

What is claimed is:

1. A sprayable water-repellent ink for a digital printing process of a fabric, comprising:
25 parts by weight to 35 parts by weight of a water repellent;
15 parts by weight to 25 parts by weight of a humectant;
0.5 parts by weight to 2 parts by weight of a surfactant; and
35 parts by weight to 60 parts by weight of a solvent,
wherein the water repellent has a pH value between 1.5 and 6 and a specific gravity between 0.8 and 1.5 at 20° C. to 25° C.

2. The sprayable water-repellent ink of claim 1, wherein the water repellent comprises a fluorine-based water repellent, a polyurethane water repellent, a silicon-based water repellent, a wax water repellent, or combinations thereof.

3. The sprayable water-repellent ink of claim 1, wherein the water repellent is an aqueous fluorocarbon polymer water repellent, and a content of the aqueous fluorocarbon polymer water repellent is 29 parts by weight to 30 parts by weight.

4. The sprayable water-repellent ink of claim 1, wherein the water repellent is an alkyl polyurethane water repellent, and a content of the alkyl polyurethane water repellent is 25 parts by weight to 30 parts by weight.

5. The sprayable water-repellent ink of claim 1, wherein a surface tension of the sprayable water-repellent ink is between 25 mN/m and 35 mN/m.

6. The sprayable water-repellent ink of claim 1, wherein a viscosity of the sprayable water-repellent ink is between 1 cP and 5 cP.

7. The sprayable water-repellent ink of claim 1, wherein each of particle diameters (D90) of the water repellent, the humectant and the sprayable water-repellent ink is between 0.001 μm and 1 μm.

8. The sprayable water-repellent ink of claim 1, wherein the humectant comprises glycerol and triethylene glycol, and a weight ratio of the glycerol to the triethylene glycol is 1.8 to 2.2.

9. The sprayable water-repellent ink of claim 1, further comprising a thickening agent, a pH modifier, a bacteriostatic agent, or combinations thereof.

10. A water-repellent fabric, comprising:
a polyester base cloth having an opposite first surface and a second surface; and
a water-repellent layer disposed on the first surface, the water-repellent layer is formed by spraying the sprayable water-repellent ink of claim 1 on the first surface through the digital printing process, wherein a water repellency of the first surface is greater than or equal to 85 under AATCC 22.
